(19) United States
(12) Patent Application Publication
(10) Pub. No.: US 2026/0018898 A1
(43) Pub. Date: Jan. 15, 2026

(54) PV MICRO-INVERTERS WITH ROBUST OFF-GRID OPERATION

(71) Applicant: SPARQ SYSTEMS INC., Kingston (CA)

(72) Inventors: Arpan LAHA, Kingston (CA); Abirami KALATHY, Kingston (CA); Majid PAHLEVANINEZHAD, Kingston (CA); Praveen JAIN, Kingston (CA)

(21) Appl. No.: 18/770,872

(22) Filed: Jul. 12, 2024

(51) Int. Cl. H02J 3/38; H02M 1/00; H02M 7/48

(52) U.S. Cl. CPC H02J 3/38; H02M 1/007; H02M 7/48; H02J 2300/26

(57) ABSTRACT

Systems and methods relating to control systems for DC/AC inverters that receive power from photovoltaic based renewable energy resources. When the DC/AC inverters are operated in on-grid mode, the DC/AC inverters and the DC/DC control system operate to provide on-grid functions such as maximum power point tracking (MPPT) and DC-bus voltage regulation. When in off-grid mode, the DC/AC inverter and the off-grid control system regulates the resulting AC voltage from the DC/AC inverter to be within a pre-set range. The off-grid control system is based on differential geometry and uses a Lie Group controller for setting a frequency reference signal. The frequency and current amplitude reference are used to generate a sinusoidal current reference signal which is then tracked by a current controller. The current controller controls the switches in the DC/AC inverter to regulate the AC voltage.

### TECHNICAL FIELD

The present invention relates to systems and methods for controlling power from renewable power sources. More specifically, the present invention relates to a control system that uses a geometric controller (based on Lie groups) for controlling currents in a DC/AC micro-inverter.

### BACKGROUND

There is a growing number of photovoltaic (PV) applications where direct current/alternating current (DC/AC) inverters are required to provide maximum power point tracking (MPPT) to harvest maximum solar energy from PV panels and then to feed clean AC electricity into the loads and/or power grid. Single-phase micro-inverters are used for various residential and commercial applications due to their attractive features such as individual MPPT, high performance, and ease of installation.

One of the main opportunities that PV micro-inverters offer is their standalone (or off-grid) operation in which they can deliver power to the loads in the absence of a grid. Due to the intermittency of solar energy, designing control systems for such systems is a challenging task. As the energy demand increases, several inverters are operated in parallel to meet the power requirement. Parallel-operated inverters have the advantages of improved power quality, lower cost, modularity, system redundancy, high reliability, etc. Droop control techniques are most commonly used for parallel operation of inverters due to their plug-and-play feature, simple implementation, reliability, and their non-requirement of communication systems.

FIG. 1 shows a block diagram of the existing solar energy harvesting systems with off-grid capability according to the prior art. A major problem in the off-grid operation of PV microinverters is the intermittency of solar power. This is exacerbated by the fact that the micro-inverters usually do not have a high amount of energy storage capacity. Usually, a relatively small DC-bus capacitor is used for storage. Hence, due to the fluctuations in the input solar power, photovoltaic off-grid systems are often complemented with energy storage systems for reliable operation as shown in FIG. 2 (Prior Art). Existing systems and devices use a smart switch to facilitate system operation between on-grid and off-grid operation/modes. The smart switch uses wireless communication (e.g. WiFi) to send instructions to various devices. This results in increased costs of the overall system. Moreover, these systems only have limited off-grid functionality and can supply power only to specific critical loads in the event of a power outage in the utility grid. As a result, such systems also require separate electrical wiring and different AC panels for partitioning the critical loads from the rest of the utility loads.

FIG. 2 shows a block diagram of a typical microinverter, according to the prior art, used for solar energy harvesting. The system also includes an energy storage system for backup during off-grid operation. These systems use either single-stage or two-stage power converters. The control system of the power converters is of great importance to provide a reliable operation for the power conditioning system.

Referring to FIG. 3, a block diagram of a typical control system, according to the prior art, for the off-grid control of a DC/AC inverter is depicted. The control system is responsible for generating a voltage within a pre-set range for operating the connected loads. This is usually done using a closed-loop control system. The AC voltage and its frequency are controlled using the droop control mechanism. For large-scale distribution systems with large feeder inductances, the inductive droop method is predominantly used. In small-scale microgrids and nanogrids, the network is resistive, and, accordingly, the resistive droop method is employed. In this resistive droop method, the AC voltage amplitude is set based on the active power and the AC voltage frequency is set based on the reactive power delivered. Using this information, a sinusoidal reference signal for the voltage is generated. Sometimes, a virtual resistance compensation technique is used to add to the stability of the resistive droop control. The control system thereafter tries to track the final voltage signal, v_{ref}, using an outer voltage control loop and an inner current control loop. The voltage controller (e.g. a proportion-integral controller or a proportional resonant controller) generates a signal that passes through a limiter block to set the current reference, i_{ref}. The current controller has a similar structure as that of the voltage controller and tracks this current reference, i_{ref}. The current controller must be designed to have a much higher bandwidth than the voltage controller. An example of the modulator block is the sinusoidal pulse-width modulator (SPWM). This modulator block takes the duty cycle reference signal, dᵢₙᵥ, from the output of the current controller and generates the gating pulses for the inverter switches.

There are several challenges with the control methods used in prior art and illustrated in the previous figures. One of the main issues with the conventional droop control technique (CDT) in the prior art is its sensitivity to the nature and magnitude of the output impedance. The droop controller needs to be modified based on the nature of output impedance to facilitate power-sharing accuracy and system stability. Some methods and devices try to estimate the nature of the output impedance and then to modify the droop law accordingly. However, these methods are not reliable and can lead to the loss of stable operation in many applications. Most systems and methods also employ a virtual impedance compensation scheme to add a virtual resistance or reactance to the network to thereby enhance the region of stability of the control scheme. However, these methods increase the voltage deviation range from the nominal set-point of the AC voltage, Vn. They can also increase distortions in the AC voltage when non-linear loads are used. This is because the sensed current, which has a high harmonic content, is fed back to the voltage control loop. Another issue with CDT is in the filtering of the noise in the current. The current needs to be filtered for calculating power. However, since the noise level in the inverter's output current is much higher than in the inverter's output voltage, the need to filter the current makes the overall system sluggish and can create issues with stability. Although some of these problems can be alleviated by known prior art methods, such methods cannot fully address various issues caused by transients and severe fluctuations in the operating conditions. As well, such methods usually fail to produce optimal performance.

Based on the above, there is therefore a need for systems and devices that mitigate if not avoid the shortcomings of the prior art.

### SUMMARY

The present invention provides systems and methods relating to control systems for DC/AC inverters that receive power from photovoltaic based renewable energy resources. When the DC/AC inverters are operated in on-grid mode, the DC/AC inverters and the DC/DC control system operate to provide on-grid functions such as maximum power point tracking (MPPT) and DC-bus voltage regulation. When in off-grid mode, the DC/AC inverter and the off-grid control system regulates the resulting AC voltage from the DC/AC inverter to be within a pre-set range. The off-grid control system is based on differential geometry and uses a Lie Group controller for setting a frequency reference signal. The frequency and current amplitude reference are used to generate a sinusoidal current reference signal which is then tracked by a current controller. The current controller controls the switches in the DC/AC inverter to regulate the AC voltage.

In a first aspect, the present invention provides a micro-inverter for use with renewable energy sources, the micro-inverter comprising:
a DC/AC inverter block producing an AC output power of said micro-inverter, said AC output power being sent by said micro-inverter to either a single-phase grid or to at least one off-grid load;
a plurality of DC/DC converters coupling said DC/AC inverter with said renewable energy sources;
a DC/DC control block for controlling said plurality of DC/DC converters based on sensed signals between said renewable energy sources and said DC/DC converters;
a DC/AC control block for controlling said DC/AC inverter based on whether said micro-inverter operates in an off-grid mode or in an on-grid mode;
   wherein
said micro-inverter operates in said off-grid mode when said AC output power is sent to said at least one off-grid load;
said micro-inverter operates in said on-grid mode when said AC output power is sent to said single-phase grid.

In a second aspect, the present invention provides a DC/AC controller for use in off-grid operation of a micro-inverter, the DC/AC controller comprising:
a current controller sub-block;
a modulator sub-block;
a current reference generator;
an amplitude control sub-block;
a frequency control sub-block that includes an integrator sub-block and a geometric Lie group controller;
   wherein
said micro-inverter includes a DC/AC inverter block producing an AC output power of said micro-inverter from at least one energy source, said AC output power being sent by said micro-inverter to at least one off-grid load when said micro-inverter is in said off-grid operation;
an output of said current controller sub-block is an input to said modulator sub-block;
said geometric Lie group controller produces a current frequency reference signal;
an output of said modulator sub-block is used to control inverter switches in a DC/AC inverter of said micro-inverter;
said current controller sub-block receives an output current of said micro-inverter;
a reference current signal output of said current reference generator is received by said current controller sub-block;
said frequency control sub-block receives an output voltage of said micro-inverter and produces a phase angle reference of an output current of said micro-inverter;
said integrator sub-block integrates said current frequency reference signal to produce said phase angle reference, said phase angle reference being received by said geometric Lie group controller;
said amplitude control sub-block produces direct and quadrature components of said output current of said micro-inverter based on said output voltage of said micro-inverter;
said current reference generator receives said direct and quadrature components of said output current and said phase angle reference to produce said reference current output.

In a further aspect, said DC/AC control block comprises:—an on-grid control sub-block;—an off-grid control sub-block;—a current controller sub-block;—a modulator sub-block; and wherein
an input to the current controller sub-block is controlled by a switch such that the input is either an output of the on-grid control sub-block or an output of said off-grid control sub-block;
an output of the current controller sub-block is an input to the modulator sub-block;
an output of the modulator sub-block is an output of the DC/AC control block and is used to control inverter switches in the DC/AC inverter; and
the current controller sub-block receives an output current of the micro-inverter.

In yet a further aspect, the on-grid control sub-block implements at least one on-grid function using the DC/AC inverter, the at least one on-grid function including at least one of:—bus voltage regulation;—reactive VAR compensation;—maximum power point tracking; and—frequency-watt compensation.

In a further aspect, the off-grid control sub-block comprises:
a current reference generator;
an amplitude control sub-block;
a frequency control sub-block that includes an integrator sub-block and a geometric Lie group controller;
   wherein
a reference current signal output of the current reference generator is received by current controller sub-block;
the frequency control sub-block receives an output voltage of the micro-inverter and produces a phase angle reference of an output current of the micro-inverter;
the geometric Lie group controller produces a current frequency reference signal;
integrator sub-block integrates the current frequency reference signal to produce the phase angle reference, the phase angle reference being received by the geometric Lie group controller;
the amplitude control sub-block produces direct and quadrature components of the output current of the micro-inverter based on the output voltage of the micro-inverter;
the current reference generator receives the direct and quadrature components of the output current and said phase angle reference to produce the reference current output.

In yet a further aspect, the geometric Lie group controller comprises—an SO(2) rotation sub-block;—a current rotation sub-block;—a logarithm calculation sub-block;—a vee operator sub-block;—a gain block; and—a summation block. In the Lie group controller, the SO(2) rotation sub-block receives the output voltage and a transpose of a current rotation matrix and produces a rotation matrix. The rotation matrix contains a phase angle difference between a voltage angle and the current angle while the logarithm calculation sub-block receives the rotation matrix and maps elements in a Lie group SO(2) to a Lie algebra using a logarithmic map. The vee operator sub-block receives an output of the logarithm sub-block and maps elements in the Lie algebra to R (set of real numbers) to produce the phase angle difference between the voltage angle and the current angle. The gain block receives an output of the vee operator sub-block and multiplies the output of the vee operator sub-block with a positive gain constant. The summation block receives an output of the gain block and adds the output of the gain block with a nominal value of the current frequency reference signal to produce the current frequency reference signal. The current rotation sub-block receives the phase angle reference to produce the transpose of the current rotation matrix in a Lie group SO(2).

Yet a further aspect provide for an amplitude control sub-block that comprises—an orthogonal signal generation sub-block;—an amplitude calculation sub-block;—a summation sub-block;—a sine sub-block;—a multiplier sub-block;—a positive gain block; and a negative gain block. In this aspect, the orthogonal signal generation sub-block receives the voltage output and the current frequency reference and produces orthogonal components of the output voltage. The amplitude calculation sub-block receives the orthogonal components and produces an amplitude of the voltage output. The sine sub-block produces the sine value of the phase angle difference. The multiplier sub-block multiplies an output of the sine sub-block and the amplitude of said voltage output. The summation sub-block subtracts the amplitude of the voltage output from a nominal value of the amplitude of the voltage output. The positive gain sub-block applies a positive gain constant to an output of the summation sub-block to produce the direct component of the output current. The negative gain sub-block applies a negative gain constant to an output of the multiplier sub-block to produce the quadrature component of the output current.

In a further aspect, the orthogonal signal generation sub-block is a second-order generalized integrator. Similarly, the current controller sub-block is a proportional-resonant (PR) controller.

In yet a further aspect, the orthogonal signal generator sub-block comprises:-a first summation sub-block;—a gain sub-block;—a second summation sub-block;—a first multiplier sub-block;—a first integrator sub-block;—a second integrator sub-block; and a second multiplier sub-block. In this aspect, the first summation sub-block receives the voltage output and a first orthogonal component of said voltage output with the first summation sub-block subtracting the first orthogonal component from the voltage output. As well, the gain sub-block receives an output of the first summation sub-block and applies a constant gain to the output of the first summation sub-block. The second summation sub-block receives an output of the gain sub-block and subtracts a second orthogonal component of the voltage output from the output of said gain sub-block. The first multiplier sub-block receives an output of the second summation sub-block and multiplies the output of the second summation sub-block with the current frequency reference. The first integrator sub-block receives an output of the first multiplier sub-block and integrates the output of the first multiplier sub-block to produce the first orthogonal component of the voltage output. Similarly, the second integrator sub-block receives the first orthogonal component of the voltage output and integrates the first orthogonal component of the voltage output. The second multiplier sub-block receives an output of the second integrator sub-block and multiplies the output of the second integrator sub-block with the current frequency reference to produce the second orthogonal component of the voltage output.

### BRIEF DESCRIPTION OF THE DRAWINGS

The embodiments of the present invention will now be described by reference to the following figures, in which identical reference numerals in different figures indicate identical elements and in which:

FIG. 1 is a block diagram of an existing solar energy harvesting system with off-grid capability according to the prior art;

FIG. 2 is a block diagram of a PV off-grid system with energy storage system according to the prior art;

FIG. 3 is a block diagram of a control system for off-grid control of a DC/AC inverter according to the prior art;

FIG. 4 is a block diagram of a single-phase micro-inverter according to one aspect of the present invention;

FIG. 5 is a block diagram of a DC/AC control system for off-grid operation according to another aspect of the present invention;

FIG. 6 is a block diagram of a frequency control block using a Geometric Lie Group controller according to another aspect of the present invention;

FIG. 7 illustrates a region of operation on the Lie Group Manifold as used in another aspect of the present invention;

FIG. 8 is a block diagram of an amplitude reference control sub-block according to another aspect of the present invention;

FIG. 9 is a block diagram of an implementation of an orthogonal signal generation block using a second-order generalized integrator;

FIG. 10 is a vector diagram of the various components of the AC load voltage and current as in one implementation of the present invention;

FIG. 11 is a diagram illustrating a sinusoidal current reference generation block according to another aspect of the present invention;

FIG. 12 illustrates one possible implementation of a current controller using a proportional-resonant (PR) controller;

FIG. 13 is a block diagram of a resulting off-grid control system of a DC/AC micro-inverter as detailed in the description; and

FIG. 14A and FIG. 14B show inverter currents and voltages for a parallel operation of two inverters with fully inductive and fully capacitive loads.

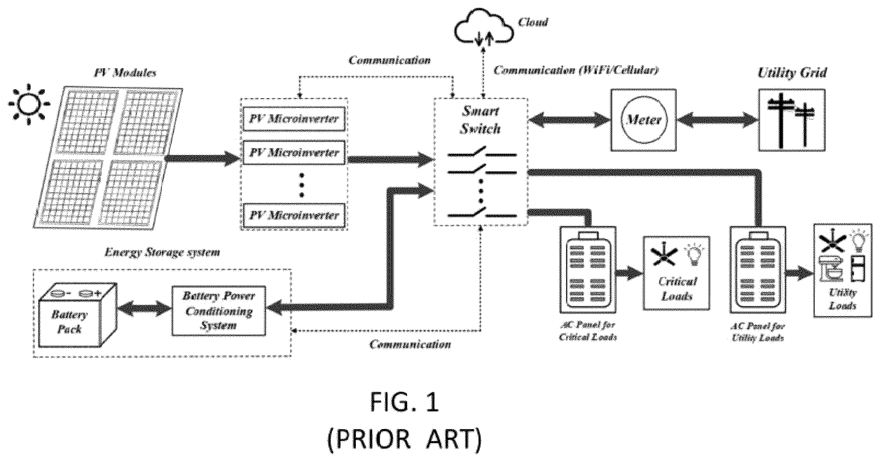

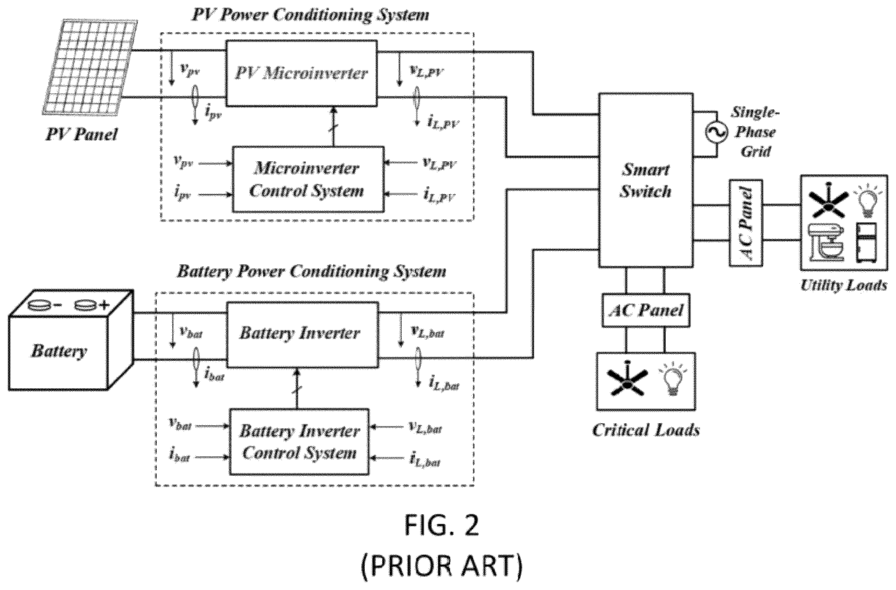

### DETAILED DESCRIPTION

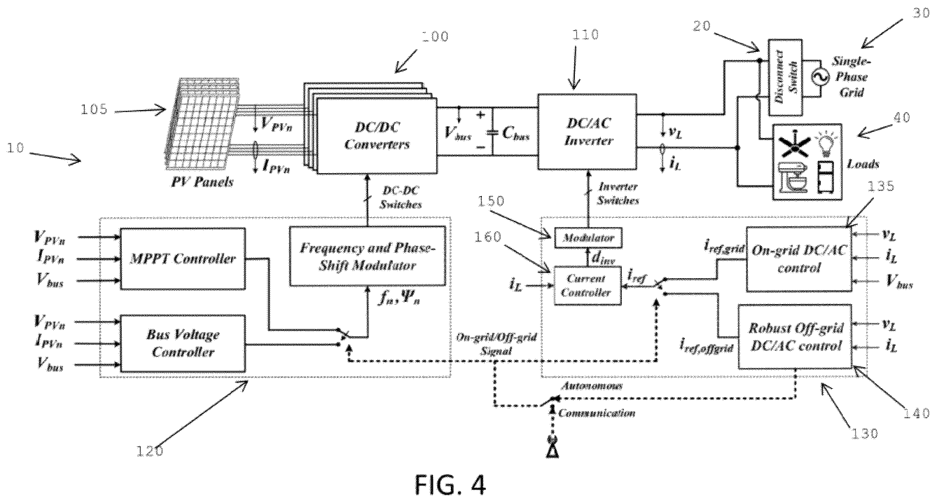

Referring to FIG. 4, a block diagram of a single-phase micro-inverter 10 with on-grid and off-grid functionality according to the present invention is shown. This system 15 of the present invention comprises of a disconnect switch 20 between a utility grid 30 and the microinverter 10 and loads 40. Unlike methods described in the prior art, the method according to another aspect of the present invention can easily alternate between off-grid and on-grid modes automatically without the use of a smart switch and without the need for communications from external devices. A command signal for operation in on-grid/off-grid mode can be sent via communication to the system if desired by the user, otherwise the system operates autonomously. The system and method allows for multiple microinverters to operate in parallel without the requirement of communication between the various microinverter units. According to FIG. 4, the system of the present invention includes the following blocks:
Multiple DC/DC Converters 100, each of which is responsible for extracting power from the PV panels 105 and delivering it to the DC bus. During the on-grid mode, the DC/DC converters 100 perform maximum power point tracking (MPPT) and feed the extracted power from the PV panels 105 to the DC bus. During the off-grid mode, each DC/DC converter 100 regulates the bus voltage to a pre-set value. Some examples of DC/DC converters 100 that can be used for this application are isolated topologies such as the full-bridge converter, series-parallel (LLC) resonant converters, etc.
A single-phase DC/AC inverter 110 that is responsible for converting the DC power at the DC-bus to a single-phase AC power compatible with the grid 30 and/or local single-phase loads 40.
A DC/DC control system 120 that is responsible for efficient power processing from the PV panels 105 for MPPT or DC bus voltage regulation. This controller 120 uses the voltage, Vₚᵥₙ, and current, Iₚᵥₙ, information at the input of the DC/DC converter and the bus voltage, V_{bus}, information at the output of the DC/DC converter 100 to generate frequency and phase-shift references for the DC/DC converters 100.
A DC/AC control system 130 that is responsible for delivering the harvested PV power to the grid 30 and/or loads 40. During the on-grid mode, this controller 130 performs various functions such as bus voltage regulation, reactive VAR compensation, frequency-watt compensation, etc. During the off-grid mode the control system 130 regulates the AC voltage to be within a pre-set range. The DC/AC control system 130 includes an on-grid control block 135, an off-grid control block 140, a modulator block 150, and a current controller block 160.

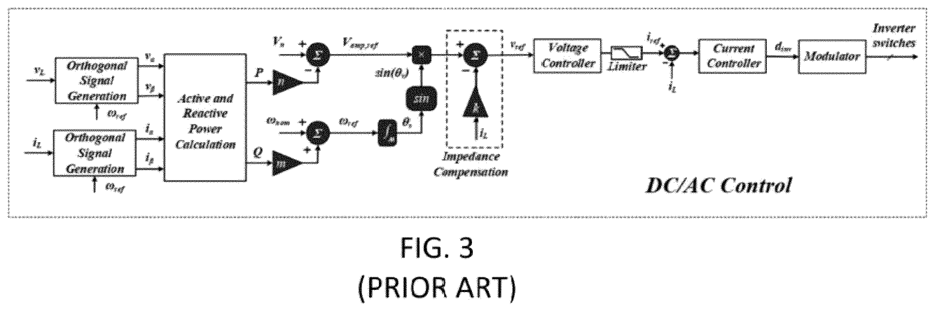

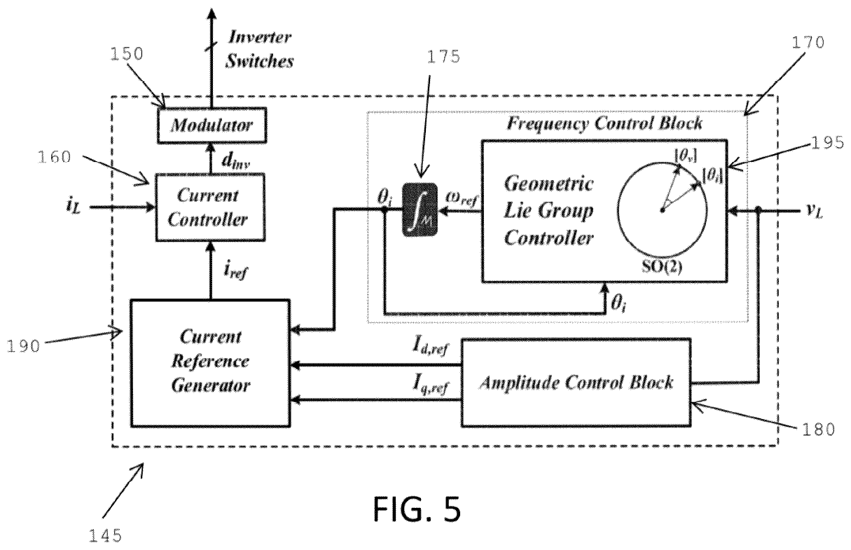

Referring to FIG. 5, illustrated is the resulting DC/AC control system when the DC/AC control system 130 operates in the off-grid mode. In off-grid mode, the off-grid control block 140 is active and the on-grid control block 135 is inactive. This resulting off-grid DC/AC control system 145 (i.e. the configuration that results when the off-grid block is active) is based on differential geometry, which allows for robust operation of the micro-inverter. The off-grid DC/AC control system 145 comprises a frequency control block 170, an amplitude control block 180, a current reference generator 190, and the current controller block 160 and the modulator block 150. Inside the frequency control block is a Lie Group controller 195 for setting the frequency reference, ω_{ref}. The phase angle reference of the current, θᵢ, is obtained by integrating ω_{ref} by way of an integrator block 175. As noted above, the control system 145 also consists of an amplitude control block 180 which generates the direct, I_{d,ref}, and quadrature, I_{q,ref}, components of the output current of the micro-inverter. The output of the amplitude control block 180 and of the frequency control block 170 are used to create the sinusoidal current reference signal, i_{ref}. This reference current signal is tracked by the current controller 160. According to FIG. 5, the method used by this off-grid DC/AC control block obviates the need for a voltage loop controller as shown in FIG. 3 (Prior Art).

As can be seen from FIG. 5, the DC/AC controller for off-grid operation includes a current controller sub-block 160, a modulator sub-block 150, a current reference generator 190, an amplitude control sub-block 180, a frequency control sub-block 170 that includes an integrator sub-block 175 and a geometric Lie group controller 195. From FIG. 5, it can be seen that an output of the current controller sub-block is an input to the modulator sub-block. Also, the geometric Lie group controller produces a current frequency reference signal and the output of the modulator sub-block is used to control inverter switches in the DC/AC inverter of the micro-inverter when the micro-inverter is operated in off-grid mode. It can, again, be seen that the current controller sub-block receives the output current of the micro-inverter. The reference current signal output of the current reference generator is received by current controller sub-block while the frequency control sub-block receives an output voltage of the micro-inverter and produces a phase angle reference of the output current of the micro-inverter. In terms of functions, the integrator sub-block integrates the current frequency reference signal to produce the phase angle reference and the phase angle reference is received by the geometric Lie group controller. For clarity, the amplitude control sub-block produces direct and quadrature components of the output current of said micro-inverter based on the output voltage of the micro-inverter. As well, the current reference generator receives this direct and quadrature components of the output current and the phase angle reference to produce the reference current output.

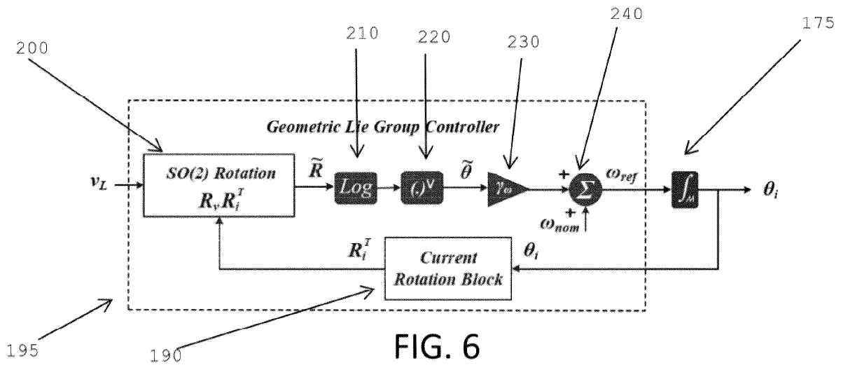

Referring to FIG. 6, an exemplary arrangement of a Geometric Lie group controller block 195 is depicted. As can be seen, the Lie group controller block 195 includes an SO(2) rotation sub-block 200, a current rotation sub-block 190, a logarithm calculation sub-block 210, a vee operator sub-block 220, a gain sub-block 230, and a summation sub-block 240. For this block, the SO(2) rotation sub-block receives the output voltage of the micro-inverter and a transpose of the current rotation matrix and produces a rotation matrix. The rotation matrix contains a phase angle difference between a voltage angle and the current angle. The logarithm calculation sub-block receives the rotation matrix and maps elements in a Lie group SO(2) to a Lie algebra using a logarithmic map. The vee operator sub-block receives an output of the logarithm sub-block and maps elements in the Lie algebra to [symbol] (the set of real numbers) to produce the phase angle difference between the voltage angle and the current angle. The gain block receives an output of the vee operator sub-block and multiplies this output of the vee operator sub-block with a positive gain constant. The summation block receives an output of the gain block and adds this output of the gain block with a nominal value of the current frequency reference signal to produce the current frequency reference signal. The current rotation sub-block receives the phase angle reference to produce the transpose of the current rotation matrix in a Lie group SO(2).

As detailed in FIG. 6, this controller block 195 generates the current frequency reference, ω_{ref}, and the current phase angle reference, θᵢ. According to FIG. 6, the Geometric Lie Group Controller block the following sub-blocks:
A Current Rotation block 190, which receives the current reference angle, θᵢ, and produces the transpose of the current rotation matrix in the Lie group SO(2) as (SO(2) is the group of Special Orthogonal matrices, which perform rotation in [symbol] ²):

$${R}_{i}^{T} ( {θ}_{i} ) = ( \begin{matrix}cos {θ}_{i} & sin {θ}_{i} \\ - sin {θ}_{i} & cos {θ}_{i}\end{matrix} )$$

A Rotation difference block 200, which calculates the rotation matrix \tilde{R} containing the phase angle difference, \tilde{θ}, between voltage angle, θ_{ν}, and current angle, θᵢ.

$$\tilde{R} = {R}_{v} {R}_{i}^{T} = ( \begin{matrix}cos {θ}_{v} & - sin {θ}_{v} \\ sin {θ}_{v} & cos {θ}_{v}\end{matrix} ) ( \begin{matrix}cos {θ}_{i} & sin {θ}_{i} \\ - sin {θ}_{i} & cos {θ}_{i}\end{matrix} ) = ( \begin{matrix}cos \tilde{θ} & - sin \tilde{θ} \\ sin \tilde{θ} & cos \tilde{θ}\end{matrix} )$$

A logarithm calculation block 210, which maps the elements in the Lie Group SO(2) to its Lie Algebra so(2) using the logarithmic map, Log(·).

$$Log : SO ( 2 ) \to 𝔰𝔬 ( 2 ) ; \tilde{R} ↦ Log ( \tilde{R} )$$

A vee operator (·)^{∧} block 220, which maps the elements in so(2) to [symbol] (so(2)≅ [symbol] ), [symbol] being the set of real numbers.

$${( . )}^{⋁} : 𝔰𝔬 ( 2 ) \to ℝ ; Log ( \tilde{R} ) ↦ \tilde{θ}$$

A gain block 230, which multiplies the output of the vee operator block 220 with a positive gain constant, γ_{ω}. The value of γ_{ω} determines how quickly the current phase angles of the parallel-connected inverters will converge to the same steady-state value. A higher value of γ_{ω} causes the inverters to synchronize faster. However, such a higher value also increases the range of frequency deviations from the nominal value, ωₙₒₘ. The nominal value is the steady-state frequency of operation of inverters for resistive loads.
A summation block 240, which adds the output of the gain block with ωₙₒₘ. Hence,

$${ω}_{ref} = {ω}_{nom} + {γ}_{ω} Log {( \tilde{R} )}^{⋁}$$

An Integrator block 175, which integrates the current reference frequency, ω_{ref}, in order to calculate the current angle, θᵢ.

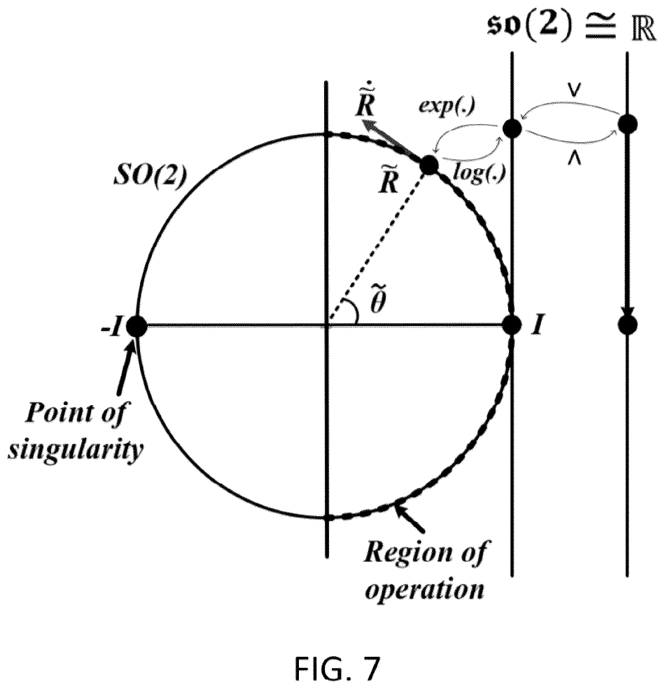

Referring to FIG. 7, the region of operation of the controller on the SO(2) manifold is depicted by dotted curved line (−π/2<\tilde{θ}<+π/2). FIG. 7 also shows the mapping of the elements of the SO(2) Lie Group to its Lie Algebra, so(2) and demonstrates the isomorphism between so(2) and [symbol] . From FIG. 7, it is clear that \tilde{θ} can only assume values from −π/2 to +π/2. Hence the topological obstruction due to the point of singularity at −I_{2×2} (\tilde{θ}=π) is automatically prevented.

To better understand the present invention, Lie groups are essentially smooth manifolds that form a group under a group operation ‘*’, such that the elements of any lie group G are closed under the group operation and satisfy the following conditions:

$$Existence of identity : ϵ * X = X * ϵ = X ∀ X ∈ 𝒢 \\ Existence of inverse : {X}^{- 1} * X = X * {X}^{- 1} = ϵ ∀ X ∈ 𝒢 \\ Associativity : X * ( Y * Z ) = ( X * Y ) * Z ∀ X , Y , Z ∈ 𝒢$$

A smooth manifold is a topological space that can be visualized as a curved structure but locally resembles a flat Euclidean space. Due to the smoothness of the manifold, a unique tangent space exists at each point of the manifold which is a linear vector space. Moreover, these tangent spaces have the same structure at all the points on the manifold.

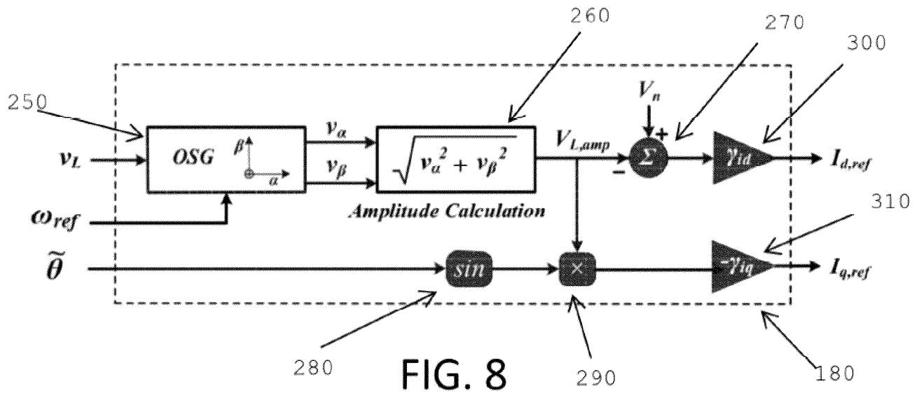

Referring to FIG. 8, an exemplary arrangement of the current amplitude reference control block 180 is illustrated. As can be seen from FIG. 8, the amplitude control block 180 includes an orthogonal signal generation sub-block (OSG) 250, an amplitude calculation sub-block 260, a summation sub-block 270, a sine sub-block 280, a multiplier sub-block 290, a positive gain block 300, and a negative gain block 310. In terms of functions and connections, the orthogonal signal generation sub-block receives the voltage output of the micro-inverter and the current frequency reference and produces orthogonal components of the output voltage of the micro-inverter. The amplitude calculation sub-block receives the orthogonal components and produces an amplitude of the voltage output. The sine sub-block produces the sine value of the phase angle difference referred to above while the multiplier sub-block multiplies an output of the sine sub-block and the amplitude of the voltage output of the micro-inverter. The summation sub-block subtracts the amplitude of the voltage output from a nominal value of the amplitude of the voltage output of the micro-inverter. The positive gain sub-block applies a positive gain constant to the output of the summation sub-block to produce the direct component of the output current while the negative gain sub-block applies a negative gain constant to the output of the multiplier sub-block to produce the quadrature component of the output current of the micro-inverter.

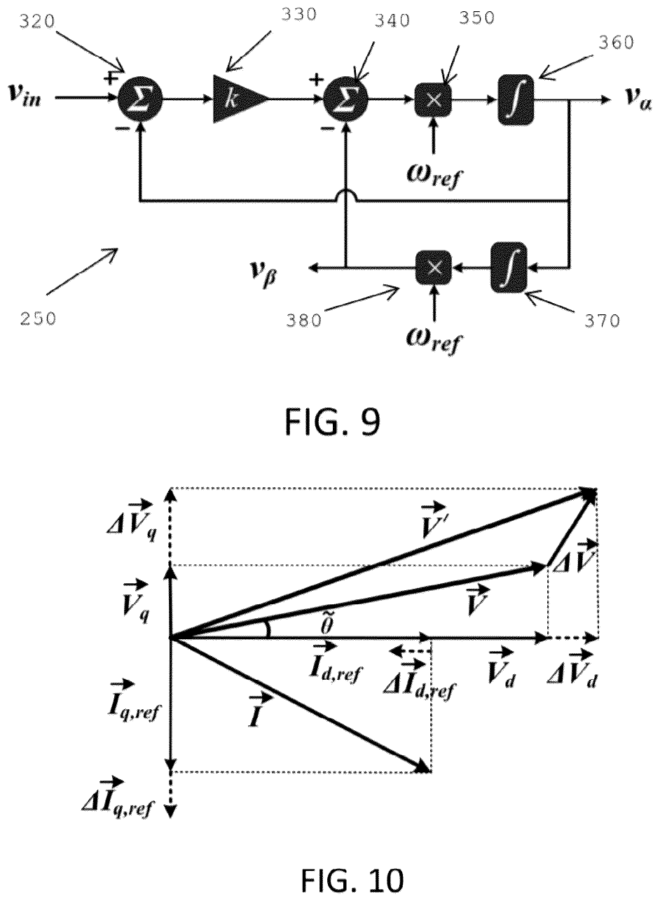

As noted above, the amplitude control block 180 generates orthogonal components of the micro-inverter output voltage ν_{L}, which are, ν_{α}, and, ν_{β}. One example of the orthogonal signal generation (OSG) block 250 is the second-order generalized integrator (SOGI) shown in FIG. 9. The amplitude, V_{L,amp}, of the voltage ν_{L} can be given as—

$${V}_{L , amp} = \sqrt{{V}_{α}^{2} + {V}_{β}^{2}}$$

This block also generates the direct and orthogonal reference current magnitudes, I_{d,ref}, and, I_{q,ref}, respectively. From this block 180, the direct current reference, I_{d,ref}, is calculated as follows

$${I}_{d , ref} = {γ}_{id} ( {V}_{n} - {V}_{L , amp} )$$

γ_{id} is a positive gain constant that controls the deviation of the output voltage amplitude, V_{L,amp}, from the nominal value, Vn. The choice of γ_{id} is determined by the regulatory requirements of the AC loads. According to FIG. 8, the quadrature current reference, I_{q,ref}, is calculated as follows

$${I}_{q , ref} = - {γ}_{iq} {V}_{L , amp} sin ( \tilde{θ} )$$

γ_{iq} is a positive gain constant. I_{q,ref} controls the quadrature component of the current reference, i_{ref}, for AC loads having a non-unity power factor.

Referring to FIG. 9, illustrated is a second-order generalized integrator (SOGI). As can be seen, this integrator includes a first summation sub-block 320, a gain sub-block 330, a second summation sub-block 340, a first multiplier sub-block 350, a first integrator sub-block 360, a second integrator sub-block 370, and a second multiplier sub-block 380.

In terms of function and connections, the first summation sub-block receives said voltage output and a first orthogonal component of said voltage output, said first summation sub-block subtracts the first orthogonal component from the voltage output of the micro-inverter. The gain sub-block receives an output of the first summation sub-block and applies a constant gain to this output of the first summation sub-block. For clarity, the second summation sub-block receives an output of the gain sub-block and subtracts a second orthogonal component of the voltage output from the output of the gain sub-block. The first multiplier sub-block receives an output of the second summation sub-block and multiplies the output of the second summation sub-block with the current frequency reference. The first integrator sub-block receives an output of the first multiplier sub-block and integrates the output of the first multiplier sub-block to produce the first orthogonal component of the micro-inverter voltage output. The second integrator sub-block receives the first orthogonal component of the voltage output and integrates the first orthogonal component of the micro-inverter voltage output. The second multiplier sub-block receives an output of the second integrator sub-block and multiplies the output of the second integrator sub-block with the current frequency reference to produce the second orthogonal component of micro-inverter voltage output.

Referring to FIG. 10, illustrated is the vector diagram of various components of the AC load voltage and current. According to FIG. 10, the vector \vec{I}_{d,ref} has been chosen as the frame of reference. The AC load voltage ν_{L} is represented by the vector \vec{V} and the load current i_{L} is represented by the vector \vec{I}. \tilde{θ} is the angle between \vec{V} and \vec{I}_{d,ref}. V_{d} (=V_{L,amp} cos(\tilde{θ})) is the magnitude of the component of the AC voltage parallel to the direction of \vec{I}_{d,ref}. V_{q} (=V_{L,amp} sin(\tilde{θ})) is the magnitude of the component of the AC voltage orthogonal to the direction of \vec{I}_{d,ref}. Hence,

$${V}_{L , amp} = \sqrt{{V}_{d}^{2} + {V}_{q}^{2}}$$

Therefore,

$${I}_{d , ref} = {γ}_{id} ( {V}_{n} - \sqrt{{V}_{d}^{2} + {V}_{{q}^{2}}} ) and {I}_{q , ref} = - {γ}_{id} {V}_{q} .$$

It can be inferred from the above equations that:

$$\frac{\partial {I}_{d , ref}}{\partial {V}_{d}} = - \frac{{γ}_{i d} {V}_{d}}{\sqrt{{V}_{d}^{2} + {V}_{q}^{2}}} < 0 \\ \frac{\partial {I}_{q , ref}}{\partial {V}_{q}} = - {γ}_{iq} < 0$$

Since the rate of change of I_{d,ref} w.r.t V_{d} and I_{q,ref} w.r.t V_{q} is negative, the control action is stable. FIG. 10 shows the changes in various components of the voltages and currents due to a small arbitrary perturbation Δ\vec{V} in the voltage vector \vec{V}. It is clear that the changes in I_{d,ref} and V_{d} are in the opposite direction. Similarly, the changes in I_{q,ref} and V_{q} are opposite to each other as well.

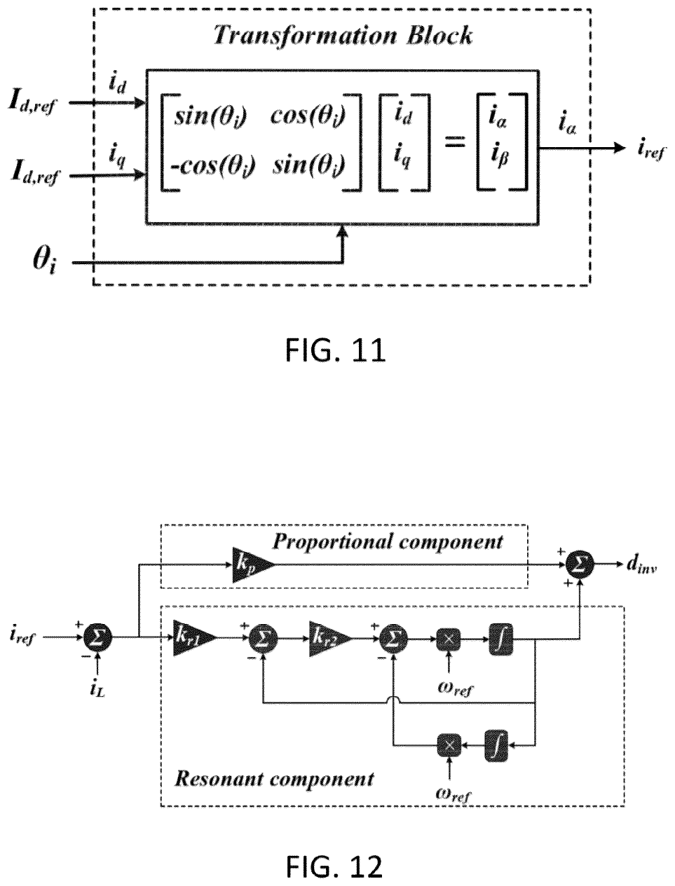

Referring to FIG. 11, an exemplary arrangement of the sinusoidal current amplitude reference control block is illustrated. This block calculates the current reference signal, i_{ref} by using a αβ−dq transformation block which has the current magnitudes I_{d,ref}, and, I_{q,ref}, as inputs from the amplitude reference control block in FIG. 8.

Referring to FIG. 12, illustrated is an example of the implementation of the current controller using a proportional-resonant (PR) controller. The controller comprises of a proportional component and a resonant component. A PR controller is preferred for this application due to its high gain at the frequency of operation. This makes the PR controller more suitable for tracking a sinusoidal reference current signal.

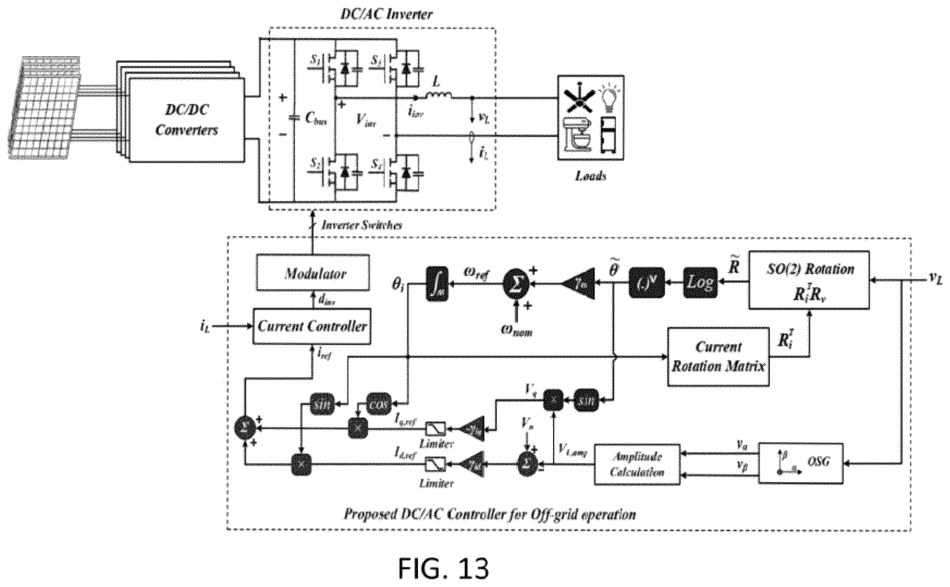

Referring to FIG. 13, illustrated is a complete off-grid control system of the DC/AC converter. As can be seen, the various components illustrated in the Figures and explained above are incorporated into the system illustrated in FIG. 13.

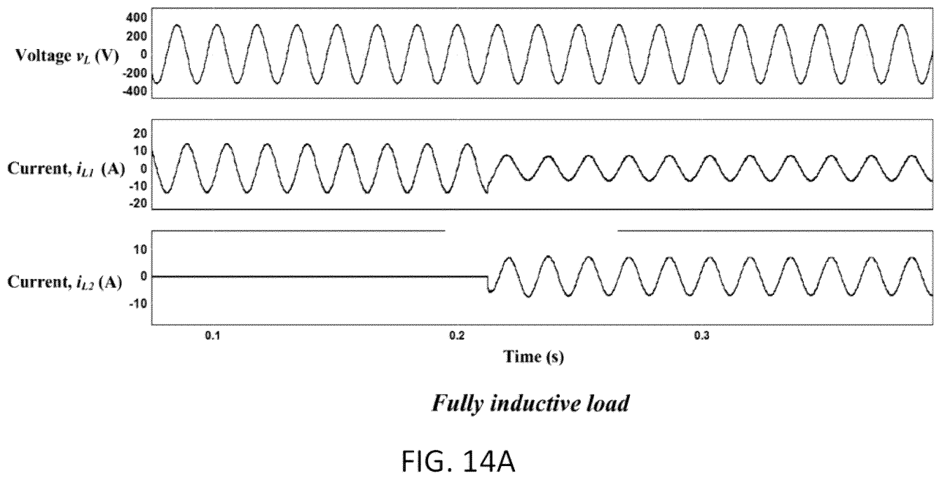

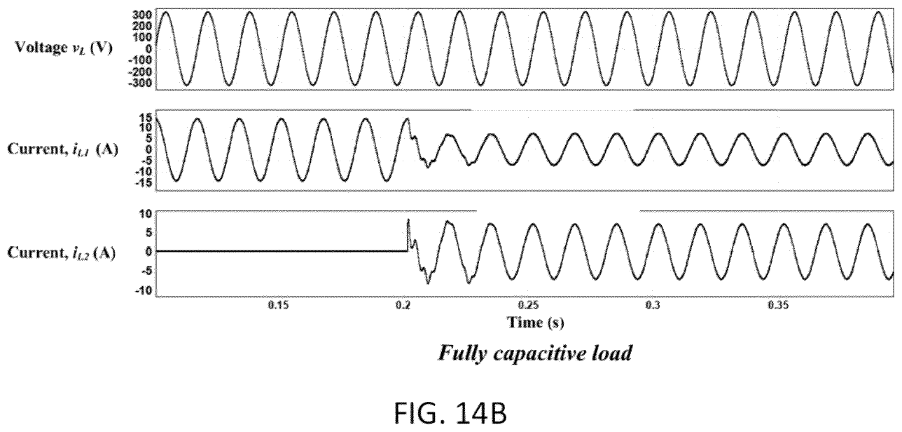

FIG. 14A and FIG. 14B show the inverter currents and voltages demonstrating the parallel operation of two inverters with fully inductive and fully capacitive loads. FIG. 14A shows the inverter currents and voltages for a parallel inverter with a fully inductive load while FIG. 14B shows the currents and voltages for parallel inverter with a fully capacitive load. It should be noted that, for the waveforms in FIG. 14A and FIG. 14B, the second inverter joins after 0.2 seconds.

A person understanding this invention may now conceive of alternative structures and embodiments or variations of the above all of which are intended to fall within the scope of the invention as defined in the claims that follow.

We claim:

1. A micro-inverter for use with renewable energy sources, the micro-inverter comprising:
a DC/AC inverter block producing an AC output power of said micro-inverter, said AC output power being sent by said micro-inverter to either a single-phase grid or to at least one off-grid load;
a plurality of DC/DC converters coupling said DC/AC inverter with said renewable energy sources;
a DC/DC control block for controlling said plurality of DC/DC converters based on sensed signals between said renewable energy sources and said DC/DC converters;
a DC/AC control block for controlling said DC/AC inverter based on whether said micro-inverter operates in an off-grid mode or in an on-grid mode;
wherein
said micro-inverter operates in said off-grid mode when said AC output power is sent to said at least one off-grid load;
said micro-inverter operates in said on-grid mode when said AC output power is sent to said single-phase grid.

2. The micro-inverter according to claim 1, wherein said DC/AC control block comprises
an on-grid control sub-block;
an off-grid control sub-block;
a current controller sub-block;
a modulator sub-block;
wherein
an input to said current controller sub-block is controlled by a switch such that said input is either an output of said on-grid control sub-block or an output of said off-grid control sub-block;
an output of said current controller sub-block is an input to said modulator sub-block;
an output of said modulator sub-block is an output of said DC/AC control block and is used to control inverter switches in said DC/AC inverter; and
said current controller sub-block receives an output current of said micro-inverter.

3. The micro-inverter according to claim 2, wherein said on-grid control sub-block implements at least one on-grid function using said DC/AC inverter, said at least one on-grid function including at least one of:
bus voltage regulation;
reactive VAR compensation;
maximum power point tracking; and
frequency-watt compensation.

4. The micro-inverter according to claim 2, wherein said off-grid control sub-block comprises:
a current reference generator;
an amplitude control sub-block;
a frequency control sub-block that includes an integrator sub-block and a geometric Lie group controller;
wherein
a reference current signal output of said current reference generator is received by said current controller sub-block;
said frequency control sub-block receives an output voltage of said micro-inverter and produces a phase angle reference of an output current of said micro-inverter;
said geometric Lie group controller produces a current frequency reference signal;
said integrator sub-block integrates said current frequency reference signal to produce said phase angle reference, said phase angle reference being received by said geometric Lie group controller;
said amplitude control sub-block produces direct and quadrature components of said output current of said micro-inverter based on said output voltage of said micro-inverter;
said current reference generator receives said direct and quadrature components of said output current and said phase angle reference to produce said reference current output.

5. The micro-inverter according to claim 4, wherein said geometric Lie group controller comprises:
a SO(2) rotation sub-block;
a current rotation sub-block;
a logarithm calculation sub-block;
a vee operator sub-block;
a gain block;
a summation block;
wherein
said SO(2) rotation sub-block receives said output voltage and a transpose of a current rotation matrix and produces a rotation matrix;
said rotation matrix contains a phase angle difference between a voltage angle and said current angle;
said logarithm calculation sub-block receives said rotation matrix and maps elements in a Lie group SO(2) to a Lie algebra using a logarithmic map;
said vee operator sub-block receives an output of said logarithm sub-block and maps elements in said Lie algebra to R to produce said phase angle difference between said voltage angle and said current angle;
said gain block receives an output of said vee operator sub-block and multiplies said output of said vee operator sub-block with a positive gain constant;
said summation block receives an output of said gain block and adds said output of said gain block with a nominal value of said current frequency reference signal to produce said current frequency reference signal;
said current rotation sub-block receives said phase angle reference to produce said transpose of said current rotation matrix in a Lie group SO(2).

6. The micro-inverter according to claim 4, wherein said amplitude control sub-block comprises:
an orthogonal signal generation sub-block;
an amplitude calculation sub-block;
a summation sub-block;
a sine sub-block;
a multiplier sub-block;
a positive gain block;
a negative gain block;
wherein
said an orthogonal signal generation sub-block receives said voltage output and said current frequency reference and produces orthogonal components of said output voltage;
said amplitude calculation sub-block receives said orthogonal components and produces an amplitude of said voltage output;
said sine sub-block produces the sine value of said phase angle difference;
said multiplier sub-block multiplies an output of said sine sub-block and said amplitude of said voltage output;
said summation sub-block subtracts said amplitude of said voltage output from a nominal value of said amplitude of said voltage output;
said positive gain sub-block applies a positive gain constant to an output of said summation sub-block to produce said direct component of said output current;
said negative gain sub-block applies a negative gain constant to an output of said multiplier sub-block to produce said quadrature component of said output current.

7. The micro-inverter according to claim 6, wherein said orthogonal signal generation sub-block is a second-order generalized integrator.

8. The micro-inverter according to claim 7, wherein said orthogonal signal generator sub-block comprises:
a first summation sub-block;
a gain sub-block;
a second summation sub-block;
a first multiplier sub-block;
a first integrator sub-block;
a second integrator sub-block;
a second multiplier sub-block;
wherein
said first summation sub-block receives said voltage output and a first orthogonal component of said voltage output, said first summation sub-block subtracting said first orthogonal component from said voltage output;
said gain sub-block receives an output of said first summation sub-block and applies a constant gain to said output of said first summation sub-block;
said second summation sub-block receives an output of said gain sub-block and subtracts a second orthogonal component of said voltage output from said output of said gain sub-block;
said first multiplier sub-block receives an output of said second summation sub-block and multiplies said output of said second summation sub-block with said current frequency reference;
said first integrator sub-block receives an output of said first multiplier sub-block and integrates said output of said first multiplier sub-block to produce said first orthogonal component of said voltage output;
said second integrator sub-block receives said first orthogonal component of said voltage output and integrates said first orthogonal component of said voltage output;
said second multiplier sub-block receives an output of said second integrator sub-block and multiplies output of said second integrator sub-block with said current frequency reference to produce said second orthogonal component of said voltage output.

9. The micro-inverter according to claim 2, wherein said current controller sub-block is a proportional-resonant (PR) controller.

10. A DC/AC controller for use in off-grid operation of a micro-inverter, the DC/AC controller comprising:
a current controller sub-block;
a modulator sub-block;
a current reference generator;
an amplitude control sub-block;
a frequency control sub-block that includes an integrator sub-block and a geometric Lie group controller;
wherein
said micro-inverter includes a DC/AC inverter block producing an AC output power of said micro-inverter from at least one energy source, said AC output power being sent by said micro-inverter to at least one off-grid load when said micro-inverter is in said off-grid operation;
an output of said current controller sub-block is an input to said modulator sub-block;
said geometric Lie group controller produces a current frequency reference signal;
an output of said modulator sub-block is used to control inverter switches in a DC/AC inverter of said micro-inverter;
said current controller sub-block receives an output current of said micro-inverter;
a reference current signal output of said current reference generator is received by said current controller sub-block;
said frequency control sub-block receives an output voltage of said micro-inverter and produces a phase angle reference of an output current of said micro-inverter;
said integrator sub-block integrates said current frequency reference signal to produce said phase angle reference, said phase angle reference being received by said geometric Lie group controller;
said amplitude control sub-block produces direct and quadrature components of said output current of said micro-inverter based on said output voltage of said micro-inverter;
said current reference generator receives said direct and quadrature components of said output current and said phase angle reference to produce said reference current output.

11. The DC/AC controller according to claim 10 wherein:
said micro-inverter includes a plurality of DC/DC converters that couple said DC/AC inverter with renewable energy sources, said renewable energy sources being said at least one energy source;
said micro-inverter including a DC/DC control block for controlling said plurality of DC/DC converters based on sensed signals between said renewable energy sources and said DC/DC converters;
and wherein
said micro-inverter operates in said off-grid mode when said AC output power is sent to said at least one off-grid load.

12. The DC/AC controller according to claim 10, wherein said geometric Lie group controller comprises:
a SO(2) rotation sub-block;
a current rotation sub-block;
a logarithm calculation sub-block;
a vee operator sub-block;
a gain block;
a summation block;
wherein
said SO(2) rotation sub-block receives said output voltage and a transpose of a current rotation matrix and produces a rotation matrix;
said rotation matrix contains a phase angle difference between a voltage angle and said current angle;
said logarithm calculation sub-block receives said rotation matrix and maps elements in a Lie group SO(2) to a Lie algebra using a logarithmic map;
said vee operator sub-block receives an output of said logarithm sub-block and maps elements in said Lie algebra to R to produce said phase angle difference between said voltage angle and said current angle;
said gain block receives an output of said vee operator sub-block and multiplies said output of said vee operator sub-block with a positive gain constant;
said summation block receives an output of said gain block and adds said output of said gain block with a nominal value of said current frequency reference signal to produce said current frequency reference signal;
said current rotation sub-block receives said phase angle reference to produce said transpose of said current rotation matrix in a Lie group SO(2).

13. The DC/AC controller according to claim 10, wherein said amplitude control sub-block comprises:
an orthogonal signal generation sub-block;
an amplitude calculation sub-block;
a summation sub-block;
a sine sub-block;
a multiplier sub-block;
a positive gain block;
a negative gain block;
wherein
said an orthogonal signal generation sub-block receives said voltage output and said current frequency reference and produces orthogonal components of said output voltage;
said amplitude calculation sub-block receives said orthogonal components and produces an amplitude of said voltage output;
said sine sub-block produces the sine value of said phase angle difference;
said multiplier sub-block multiplies an output of said sine sub-block and said amplitude of said voltage output;
said summation sub-block subtracts said amplitude of said voltage output from a nominal value of said amplitude of said voltage output;
said positive gain sub-block applies a positive gain constant to an output of said summation sub-block to produce said direct component of said output current;
said negative gain sub-block applies a negative gain constant to an output of said multiplier sub-block to produce said quadrature component of said output current.

14. The DC/AC controller according to claim 13, wherein said orthogonal signal generation sub-block is a second-order generalized integrator.

15. The DC/AC controller according to claim 14, wherein said orthogonal signal generator sub-block comprises:
a first summation sub-block;
a gain sub-block;
a second summation sub-block;
a first multiplier sub-block;
a first integrator sub-block;
a second integrator sub-block;
a second multiplier sub-block;
wherein
said first summation sub-block receives said voltage output and a first orthogonal component of said voltage output, said first summation sub-block subtracting said first orthogonal component from said voltage output;
said gain sub-block receives an output of said first summation sub-block and applies a constant gain to said output of said first summation sub-block;
said second summation sub-block receives an output of said gain sub-block and subtracts a second orthogonal component of said voltage output from said output of said gain sub-block;
said first multiplier sub-block receives an output of said second summation sub-block and multiplies said output of said second summation sub-block with said current frequency reference;
said first integrator sub-block receives an output of said first multiplier sub-block and integrates said output of said first multiplier sub-block to produce said first orthogonal component of said voltage output;
said second integrator sub-block receives said first orthogonal component of said voltage output and integrates said first orthogonal component of said voltage output;
said second multiplier sub-block receives an output of said second integrator sub-block and multiplies output of said second integrator sub-block with said current frequency reference to produce said second orthogonal component of said voltage output.
